(19) United States
(12) Patent Application Publication
(10) Pub. No.: US 2026/0225125 A1
(43) Pub. Date: Aug. 6, 2026

(54) NOZZLE FOR THE EDGEFILL AND SEALING OF A PANEL, AUTOMATED APPLICATION TOOL COMPRISING SAID NOZZLE AND METHOD OF SEALING

(71) Applicant: SAFRAN CABIN GERMANY GMBH, Herborn (DE)

(72) Inventor: Helmut Hallenberger, Herbern (DE)

(73) Assignee: SAFRAN CABIN GERMANY GMBH, Herborn (DE)

(21) Appl. No.: 19/150,819

(22) PCT Filed: Jan. 31, 2023
(86) PCT No.: PCT/EP2023/052265

§ 371 Date: Jul. 24, 2025

(51) Int. Cl. B05C 5/02

(52) U.S. Cl. CPC B05C 5/0204; B05C 5/0225

(57) ABSTRACT

This nozzle for the sealing of an open edge of a panel, said nozzle comprises a tubular portion defining a conduct, suitable for the flow of an edge fill material, and a spacer portion longitudinally prolonging the tubular portion over a partial section of the tubular portion.

### TECHNICAL FIELD

The present invention relates to the field of sealing of materials and to the field of nozzle for injecting a sealing material.

More precisely, the invention relates to a nozzle for the sealing of an open edge of a honeycomb panel, an automated application tool for the sealing of an open edge of a honeycomb panel comprising such a nozzle and a method of automated sealing of an open edge of a honeycomb panel with such an automated application tool.

### STATE OF THE ART

Aircrafts use honeycomb panels for their acoustic and/or thermic isolation. Such honeycomb panels are multi-layer structures comprising an upper flat surface, a honeycomb core, and a lower flat surface.

Some edges of the honeycomb panels require to be sealed to avoid moisture and/or insects to penetrate hollow areas of the honeycomb core.

The sealing of an open edge of a honeycomb panel is a manual application process, which is labor intensive, uses too much sealing material and is imprecise.

### SUMMARY OF THE INVENTION

Consequently, a purpose of the invention is to provide a nozzle which is suitable for the automatization of the sealing of open edges of panel. Other purposes are to apply an edge fill material uniformly, to save edge fill material and to adapt to several geometries of panel including several thicknesses and shapes.

An object of the invention is to provide a nozzle for the sealing of an open edge of a panel, said nozzle comprising a tubular portion defining a conduct suitable for the flow of an edge fill material, and a spacer portion longitudinally prolonging the tubular portion over a partial section of the tubular portion.

According to an embodiment, the partial section corresponds to a half section of the tubular portion.

Advantageously, the nozzle comprises a first flow guiding portion prolonging a first end of the spacer portion with respect to the tubular portion and/or a longitudinal gap remaining between the tubular portion and the first flow guiding portion.

According to an embodiment, the nozzle comprises a second flow guiding portion extending from the first flow guiding portion, the second flow guiding portion defining a flow guiding surface, particularly directed obliquely, away from the first guiding portion and away from the tubular portion.

Advantageously, the nozzle comprises a first smoothing surface extending longitudinally on a second end of the spacer portion, particularly the first smoothing surface being flat.

According to an embodiment, the nozzle comprises a first smoothing portion prolonging the first smoothing surface.

Advantageously, an end of the tubular portion located with respect to the spacer portion defines a transversal second smoothing surface, particularly the second smoothing surface being flat.

According to an embodiment, the nozzle comprises a second smoothing portion prolonging the second smoothing surface.

Another object of the invention is to provide an automated application tool for the sealing an open edge of a panel, said tool comprising a dosing system of an edge fill material, a nozzle as described above, and a flow pipe connected to the dosing system and to the nozzle.

Another object of the invention is to provide a method of automated sealing of an open edge of a panel, particularly with an automated application tool as described above, comprising:
a positioning step, where the nozzle is positioned against the panel so that an end of the tubular portion located with respect to the spacer portion relies on a top layer of the panel, an inner surface of the spacer portion facing the panel;
a flowing step, where the edge fill material flows; and
a moving step, where the nozzle is moved along the panel, particularly according to an automated movement which may be a translation.

### BRIEF DESCRIPTION OF THE DRAWINGS

Other advantages and features of the invention will appear from the detailed description of embodiments of the invention, which are non-limiting examples, illustrated in the appended drawings of which:

FIG. 1 is a schematic view of a panel comprising open edges to seal;

FIG. 2 is a schematic view of a nozzle according to the invention;

FIG. 3 is a top view of the nozzle of FIG. 2;

FIG. 4 is a schematic view of an automated application tool according to the invention;

FIG. 5 is a schematic view of a method of automated sealing according to the invention; and

FIG. 6 is a schematic view of the panel of FIG. 1 with an open edge sealed.

### DETAILED DESCRIPTION

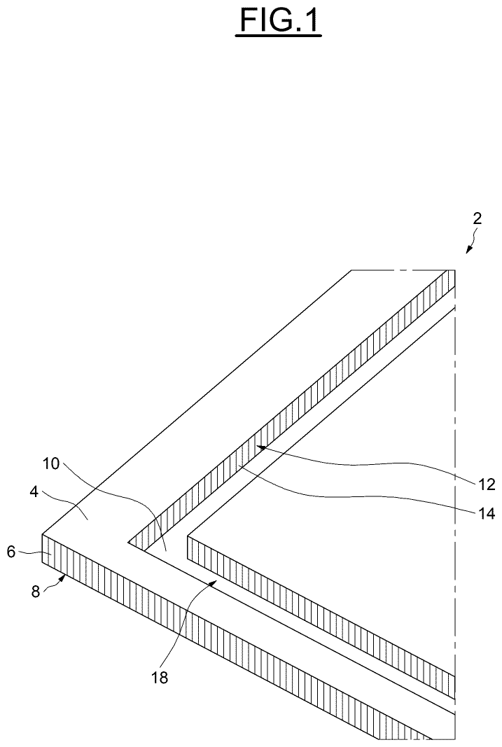

FIG. 1 shows schematically a panel 2, for example a honeycomb panel 2. The panel 2 may be a multi-layer structure comprising an upper sheet 4, a core 6, and a lower sheet 8. The upper sheet 4 and/or the lower sheet 8 may have a thickness between 0.5 and 2 mm, being 1 mm for example. The core 6 may be a honeycomb core 6 comprising, for example, a mesh of hexagonal structures, but it could comprise other shapes of mesh like rectangular or triangular structures.

The panel 2 may have been milled. The upper sheet 4 has been cut out around an area and the core 6 has been hollowed out of the upper sheet 4 and the lower sheet 8.

The panel 2 may have been milled such as to reveal an upper surface 10 of the lower sheet 8.

Such cutout creates walls 12 within the core 6 comprising cavities 14 to seal.

In the present case, the walls 12 are vertical, but such walls 12 could be in a slant direction.

Such arrangement defines an open edge 18 of the panel 2. The open edge 18 may comprise the walls 12 with cavities 14 to seal.

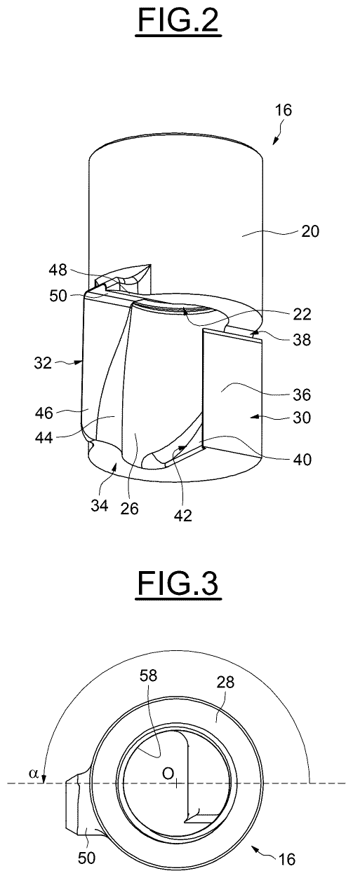

FIG. 2 shows schematically a nozzle 16 for the sealing of the open edge 18 of the panel 2.

The nozzle 16 comprises a tubular portion 20 defining a conduct 22. Here, the tubular portion 20 has the shape of a circular cylinder. Nevertheless, the tubular portion 20 may have other tubular shapes, for example the shape of a hexagonal cylinder or the shape of a cylinder with another polygonal section.

A section of the conduct 22 may have a shape like the shape of a section of the tubular portion 20 with walls of the tubular portion 20 of constant thickness. In the case of FIG. 2, the conduct 22 has the shape of a circular cylinder.

The conduct 22 is adapted for the flow of an edge fill material 24, said edge fill material 24 being adapted for sealing cavities 14 of the open edge 18. Preferably, said edge fill material 24 is certified FST, i.e., Fire-Smoke-Toxicity.

The nozzle 16 comprises a spacer portion 26 longitudinally prolonging the tubular portion 20 over a partial section of the tubular portion 20. Preferably, the height of the tubular portion 20 corresponds to the height of the open edge 18 added to the thickness of the upper sheet 4. Thus, the nozzle 16 can seal the whole open edge 18.

By prolonging the tubular portion 20 over a partial section of the tubular portion 20, it is meant that the spacer portion 26 prolongs the tubular portion 20 over a radial sector of a section of the tubular portion 20, said section being intended to be in a downstream direction of the flow of the edge fill material 24.

FIG. 3, which is a top view of the nozzle 16 of FIG. 2, shows that the radial sector is defined by the part of a section 28 of the tubular portion 20 comprised between a first angular value and a second angular value. The first angular value and the second angular values are defined with respect to the center of mass of the section of the tubular portion 20. For example, if the section of the tubular portion 20 is a disk and the first angular value and the second angular value are 0 and 90°, the part of the section 28 is a quarter of a disk and the spacer portion 26 has the shape of a quarter of a hollow circular cylinder.

FIG. 2 shows the spacer portion 26 prolonging the tubular portion 20 over a half section of the tubular portion 20. Specifically, the spacer portion 26 is a half-circular hollow cylinder. Here, the part of the section 28 of the tubular portion 20 corresponds to the half section of the tubular portion 20.

The nozzle 16 can apply the edge fill material 24 in a uniform and thorough manner to the cavities 14 of the open edge 18. Particularly the nozzle 16 can apply a suitable amount of the edge fill material 24.

In one embodiment, the nozzle 16 comprises a plastic material, for example the I151FDA by Igus®. Optionally, the nozzle 16 is made by printing. Preferably, the nozzle 16 is made in one piece.

The spacer portion 26 has a first end 30, a second end 32 and a free end 34. The first end 30 corresponds to prolonging of the tubular portion 20 along the first angular value, here 0 degree. The second end 32 corresponds to the prolonging of the tubular portion 20 along the second angular value, here 180 degrees. The free end 34 is longitudinally opposed to the tubular portion 20 and is intended to be in a downstream direction of the flow of the edge fill material 24.

The nozzle 16 comprises a first flow guiding portion 36 prolonging the first end 30 of the spacer portion 26 with respect to the tubular portion 20.

A longitudinal gap 38 remains between the tubular portion 20 and the first flow guiding portion 36. The first flow guiding portion 36 is intended to be oriented to the open edge 18 to seal.

The upper sheet 4 of the panel 2 is intended to slip into the longitudinal gap 38 to guide the nozzle 16. The height of the longitudinal gap 38 is of a dimension close to the thickness of the upper sheet 4.

The first flow guiding portion 36 is intended to guide the flow of the edge fill material 24.

The nozzle 16 comprises a second flow guiding portion 40 extending from the first flow guiding portion 36. The second flow guiding portion 40 defines a flow guiding surface 42, particularly directed obliquely, away from the first flow guiding portion 36 and away from the tubular portion 20. The flow guiding surface 42 is intended to guide the flow of the edge fill material 24.

The second end 32 of the spacer portion 26 comprises a first smoothing surface 44, for example extending longitudinally. Particularly the first smoothing surface 44 may be flat. By being flat, it is meant that a roughness of the first smoothing surface 44 is adapted to a roughness of the desired sealing of the open edge 18. For example, if the sealing of the open edge 18 must be smooth, the first smoothing surface 44 must appear smooth when a human touch it.

Preferably, the shape of the first smoothing surface 44 is adapted to the shape of the open edge 18. For example, the shape of the first smoothing surface 44 is complementary to the shape of the walls 12 of the open edge 18.

The first smoothing surface 44 is intended to smooth the edge fill material 24 along the wall 12 of the panel 2.

For example, the sealed open edge 18 has a rugosity comprised between 5 and 50 μm.

Optionally, the nozzle 16 may comprise a first smoothing portion 46 prolonging the first smoothing surface 44. The first smoothing portion 46 is intended to smooth the edge fill material 24.

Here, the first smoothing portion 46 prolongs the first smoothing surface 44 in the plane of the first smoothing surface 44 and away from the first flow guiding portion 36.

As a variant, the first smoothing portion 46 prolongs the first smoothing surface 44 in the plane of the first smoothing surface 44 in the direction of the first flow guiding portion 36. As another variant, the first smoothing portion 46 prolongs the first smoothing surface 44 in another direction.

An end of the tubular portion 20 may be located with respect to the spacer portion 26.

Such end of the tubular portion 20 is intended to be downstream to guide the flow of the edge fill material 24. Such end of the tubular portion 20 defines a second smoothing surface 48, specifically a transversal second smoothing surface 48. Particularly, the second smoothing surface 48 may be flat.

Optionally, the nozzle 16 may comprise a second smoothing portion 50 prolonging the second smoothing surface 48. The second smoothing portion 50 is intended to smooth the edge fill material 24.

Here, the second smoothing portion 50 prolongs the second smoothing surface 48 in the plane of the second smoothing surface 48 and away from the conduct 22.

As a variant, the second smoothing portion 50 prolongs the second smoothing surface 48 in the plane of the second smoothing surface 48 in the direction of the conduct 22. As another variant, the second smoothing portion 50 prolongs the second smoothing surface 48 in another direction.

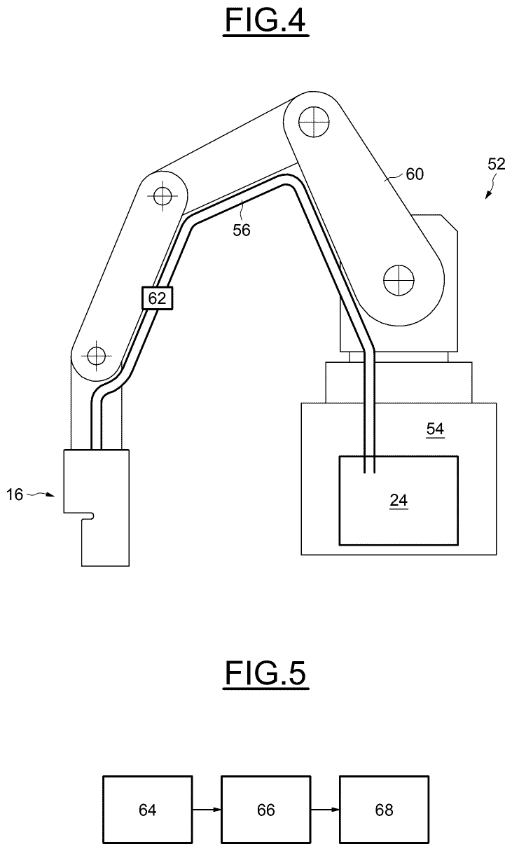

FIG. 4 is a schematic view of an automated application tool 52 for the sealing of the open edge 18. The automated application tool 52 comprises the nozzle 16 as described above and a dosing system 54 containing the edge fill material 24.

The automated application tool 52 also comprises a flow pipe 56 connected, on the one end, to the dosing system 54 and, on the other end, to the nozzle 16.

The dosing system 54 can inject the edge fill material 24, so the edge fill material 24 circulates from the dosing system 54 to the flow pipe 56, to the nozzle 16 and to the open edge 18 to seal.

Optionally, the dosing system 54 can mix the edge fill material 24, so the edge fill material 24 does not require hand mixing.

Preferably, the nozzle 16 comprises a thread on an interior wall 58 of the tubular portion 20 and the flow pipe 56 comprises a complementary thread to link the flow pipe 56 to the nozzle 16.

In variant, the nozzle 16 can be connected to the nozzle 16 with another connecting mean.

Preferably, the automated application tool 52 comprises a robotic arm 60 which is suitable to move the nozzle 16 along the open edge 18.

In addition, the automated application tool 52 may comprise at least one position sensor 62, for example, a strength sensor or a distance sensor. Moreover, the automated application tool 52 may use direct engineering data to move the nozzle 16 to seal the open edge 18.

The automated application tool 52 can move the nozzle 16 according to the open edge 18 geometry. In particular, the automated application tool 52 can move the nozzle 16 around corners or circular portion of the open edge 18.

The automated application tool 52 may comprise other sensors to control and/or ensure the perfect process of the sealing, like an optical sensor. The automated application tool 52 can implement a process shown on FIG. 5 which is a schematic view of a method of automated sealing according to the invention.

First, at a positioning step 64, the nozzle 16 is positioned against the panel 2 so that an end of the tubular portion 20 located with respect to the spacer portion 26 relies on a top layer of the panel 2 and/or an inner surface of the spacer portion 26 facing the panel 2.

For example, the second smoothing surface 48 relies on the upper sheet 4 of the panel 2. Moreover, the upper sheet 4 may be engaged in the longitudinal gap 38. The free end 34 of the spacer portion 26 relies on the upper surface 10 of the lower sheet 8.

Preferably, before the positioning step 64, a human operator may choose a nozzle 16 with the spacer portion 26 having an applicable height corresponding to the open edge 18 to seal and may connect said nozzle 16 onto the flow pipe 56 of the automated application tool 52.

Second, at a flowing step 66, the flow of the edge fill material 24 begins. For example, the dosing system 54 containing the edge fill material 24 sets in motion the edge fill material 24 from the dosing system 54 to the nozzle 16.

The edge fill material 24 flows inside the conduct 22 and is oriented by the first flow guiding portion 36 and/or by the second flow guiding portion 40. The first flow guiding portions 36 and the second flow guiding portion 40 increase the accuracy of the sealing by correctly orienting the flow of the edge fill material 24.

Next, at a moving step 68, the nozzle 16 is moved along the panel 2, the application movement being in the direction from the second end 32 of the spacer portion 26 to the first end 30 of the spacer portion 26.

For example, the robotic arm 60 uses direct engineering data coming from the position sensors 62 to move the nozzle 16 along the open edge 18.

Alternatively, a simulation program generated by a simulation software may define the exact track and position of the application movement to move the robotic arm 60 appropriately.

A strength sensor may detect that the nozzle 16 is rightly positioned regarding the panel 2, for example, in contact with the panel 2, the upper sheet 4 remaining in the longitudinal gap 38.

The first smoothing surface 44 smooths the edge fill material 24 along the wall 12 of the panel 2 and/or the second smoothing surface 48 smoothing the edge fill material 24 on the upper sheet 4.

The first smoothing portion 46 enhances the smoothing of the edge fill material 24 along the wall 12 of the panel 2 to seal.

The second smoothing portion 50 enhances the smoothing of the edge fill material 24 on the upper sheet 4. Preferably, the second smoothing portion 50 can smooth all the edge fill material 24 applied on the upper sheet 4 by the nozzle 16.

Optionally, a gap remains between the wall 12 of the open edge 18 and the first smoothing portion 46 and/or the first smoothing surface 44. Such gap defines the thickness of the seal along the wall 12.

A similar gap may remain between the upper sheet 4 and the second smoothing portion 50 and/or the second smoothing surface 48. Such similar gap defines the thickness of the seal on the upper sheet 4.

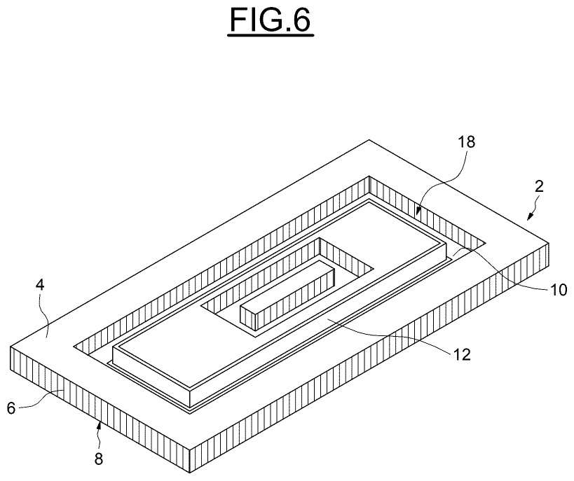

FIG. 6 is a schematic view of the panel 2 of the FIG. 1 after the sealing of the open edge 18.

1. Nozzle for the sealing of an open edge of a panel, said nozzle comprising a tubular portion defining a conduct, suitable for the flow of an edge fill material, and a spacer portion longitudinally prolonging the tubular portion over a partial section of the tubular portion.

2. Nozzle according to claim 1, wherein the partial section corresponds to a half section of the tubular portion.

3. Nozzle according to claim 1, comprising a first flow guiding portion prolonging a first end of the spacer portion with respect to the tubular portion and/or a longitudinal gap remaining between the tubular portion and the first flow guiding portion.

4. Nozzle according to claim 3, comprising a second flow guiding portion extending from the first flow guiding portion, the second flow guiding portion defining a flow guiding surface, particularly directed obliquely, away from the first guiding portion and away from the tubular portion.

5. Nozzle according to claim 1, comprising a first smoothing surface extending longitudinally on a second end of the spacer portion, particularly the first smoothing surface being flat.

6. Nozzle according to claim 5 comprising a first smoothing portion prolonging the first smoothing surface.

7. Nozzle according to claim 1, wherein an end of the tubular portion located with respect to the spacer portion defining a transversal second smoothing surface, particularly the second smoothing surface being flat.

8. Nozzle according to claim 7, comprising a second smoothing portion prolonging the second smoothing surface.

9. Automated application tool for the sealing an open edge of a panel, said tool comprising a dosing system of an edge fill material, a nozzle according to claim 1 and a flow pipe connected to the dosing system and to the nozzle.

10. Method of automated sealing of an open edge of a panel, particularly with an automated application tool according to claim 9, comprising:
A positioning step, where the nozzle is positioned against the panel so that an end of the tubular portion located with respect to the spacer portion relies on a top layer of the panel, an inner surface of the spacer portion facing the panel;
a flowing step, where the edge fill material flows; and
a moving step, where the nozzle is moved along the panel, particularly according to an automated movement which may be a translation.
